(19) United States
(12) Patent Application Publication
(10) Pub. No.: US 2011/0107070 A1
(43) Pub. Date: May 5, 2011

(54) PATCHING OF A READ-ONLY MEMORY

(76) Inventors: Grig Barbulescu, Moreni (RO); Nicusor Penisoara, Bucharest (RO)

(21) Appl. No.: 12/997,087

(22) PCT Filed: Jun. 23, 2008
(86) PCT No.: PCT/IB08/52473

§ 371 Date: Dec. 9, 2010

(51) Int. Cl. G06F 9/318

(52) U.S. Cl. 712/226; 712/E09.035

(57) ABSTRACT

An information processing device comprises a memory carrying a program, and a processor capable of executing the program. The program instructs the processor to determine whether a selected identifier is contained in a set of identifiers, and, if the processor has determined that the identifier is contained in the set of identifiers, to execute a patch instruction identified by the identifier, and, if the processor has determined that the identifier is not contained in the set of identifiers, to execute an original instruction identified by the identifier. The memory may comprise a read-only memory (ROM) and a random access memory (RAM), the ROM carrying the original instruction and the RAM carrying the patch instruction and the set of identifiers. A method of executing a program on an information processing device and a method of modifying a program on an information processing device are also disclosed.

### FIELD OF THE INVENTION

This invention relates to an information processing device comprising a memory carrying a program, and a processor capable of executing the program.

The invention further relates to a method of executing a program on an information processing device.

The invention also relates to a method of modifying a program on an information processing device.

### BACKGROUND OF THE INVENTION

An information processing device generally comprises a memory on which a program has been stored and a processor capable of executing that program. The program may, for example, contain instructions for performing calculations, treating input data, or generating output signals. Various types of memory devices exist, including optical storage devices and magnetic storage devices. A read-only memory (ROM) allows data to be read from it but not to modify the data on it. In contrast, a random access memory (RAM) allows for both reading data from it and writing data to it, or modifying existing data on it. Thus, a RAM is far more versatile than a ROM. Nevertheless ROMs are widely used in many applications requiring a permanent storage of the same data, e.g. storage of program instructions that are to be executed many times during the lifetime of a device. While the costs of developing a particular ROM are typically many times higher than the costs of programming a RAM to perform the same function, the high development costs may be compensated by a very low per-unit production cost of the final ROM. Usually a ROM also consumes significantly less electrical power than a RAM. A program that is to be burnt or otherwise written to a ROM usually undergoes an extensive testing phase before the final ROM is produced on a mass scale. Nonetheless, after the final ROM or a product containing the ROM has been released, errors may be detected in the code stored in the ROM, or other reasons may appear which would make it desirable to modify the program stored in the ROM.

Methods for correcting the program stored in a ROM, so called ROM-patching methods, have therefore been developed. Examples of such methods have been described in, for example, U.S. Pat. No. 6,260,157 B1 and references therein.

A ROM-patching method typically involves a second memory that is distinct from the ROM and in which so called patch instructions are stored, each patch instruction replacing an original instruction in the ROM during execution of the program. The second memory is typically a RAM. When executing the patched program, the processor typically reads the majority of instructions from the ROM and, when reaching a so called jump point, executes a patch instruction instead of a corresponding original instruction. Executing the patch program customarily involves a jump table which allocates a memory address to each jump point of the program. When reaching a jump point in the program, the processor reads from the jump table the memory address associated with that jump point and jumps to that address for executing the code stored there. The memory address may be an address in the ROM, or, in the case of a patched instruction, an address in the RAM. Thus each memory address stored in the jump table refers either to an original portion of code stored in the RAM or to a patch code stored in the RAM.

A disadvantage is the amount of memory required for storing the jump table in the RAM. It is noted that the size of the jump table is proportional to the number of jump points provided in the program stored in the ROM and independent of the number of actual modifications (patches) of the program. In particular the jump table also comprises all those memory addresses referring back to the ROM. Thus patching methods relying on the use of a jump table require a fixed minimum amount of memory in the RAM, even if the program does not include any patches.

### SUMMARY OF THE INVENTION

The present invention provides an information processing device, a method of executing a program, and a method of modifying a program as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Identical reference numerals are used to indicate similar or analogous components.

FIG. 1 schematically shows an example of a generic information processing device.

FIG. 2 shows a flow chart illustrating an example of a prior art ROM-patching method.

FIG. 3 schematically illustrates an example of a prior art information processing device comprising a ROM carrying original instructions and a RAM carrying patch instructions.

FIG. 4 shows a flow chart illustrating in a simplified manner an example of a ROM-patching method according to the invention.

FIG. 5 schematically illustrates an example of an information processing device according to the invention.

FIG. 6 schematically illustrates an example of a method of modifying a program on an information processing device according to the invention.

### DETAILED DESCRIPTION OF THE PREFERRED EMBODIMENTS

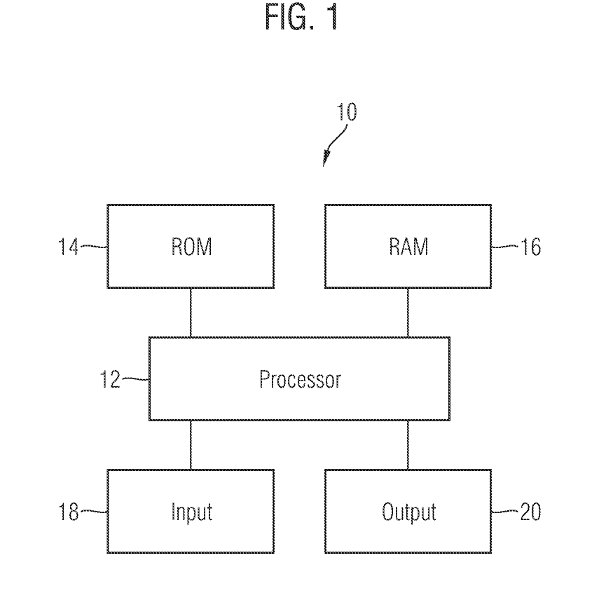

Shown in FIG. 1 is an example of a generic information processing device 10, comprising a processor 12 operably connected to a read-only memory (ROM) 14, to a random-access memory (RAM) 16, to an input 18 and to an output 20. Stored in the ROM 14 is a program comprising instructions to be read and executed by the processor 12. The program may, for example, instruct the processor to read input signals from the input 18, to perform certain logical operations, for example, calculations depending on the data read from the input 18, and generate output signals to be received by the output 20. The input 18 may, for example, comprise a keyboard for entering alphanumerical constants, or a sensor for measuring a physical quantity such as a temperature, an electromagnetic field, or a gas pressure. The input may in particular comprise an antenna for receiving electromagnetic radiation. The output 20 may comprise a display, for example a liquid crystal display (LCD), or an acoustic signalling device. The RAM 16 serves in particular for storing data generated by the processor 12 when executing the program stored in the ROM 14. The RAM 16 usually carries a jump table the entries of which are memory addresses of instructions to be executed by the processor. While the vast majority of these instructions are stored in the ROM 14, some of the instructions are patch instructions stored in the RAM 16. Each of the patch instructions stored in the RAM replaces an original instruction stored in the ROM 14 in the sense that during execution of the program the patch instruction is executed instead of the original instruction. It is noted that each memory address stored in the jump table may be modified at will and hence offers a possibility of modifying the program. Depending on the number of its entries, the jump table may occupy a non-negligible portion of the memory space provided by the RAM. For example, the jump table may occupy tens or hundreds of kilobytes. The size of the jump table is directly proportional to the number of jump points defined in the ROM 14 and hence is independent of the actual number of patch instructions provided in the RAM 16.

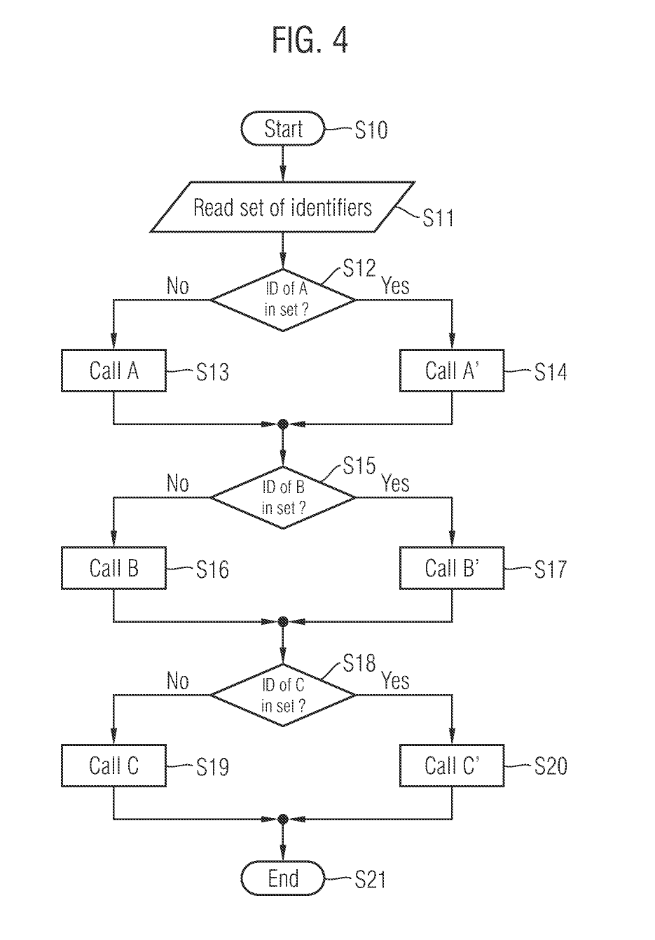

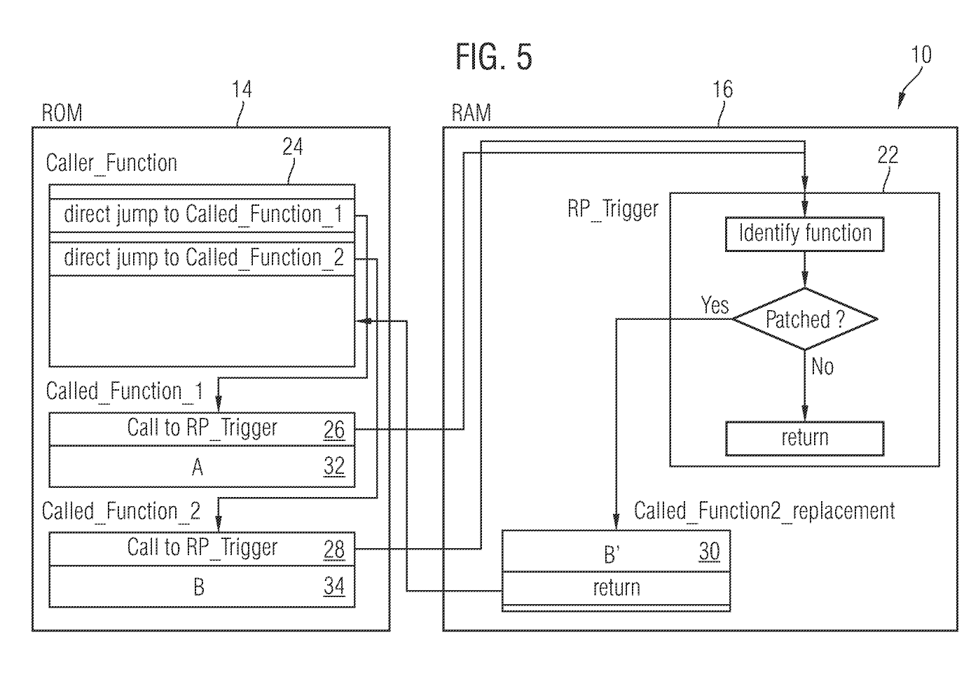

It is realized that different patching methods can be implemented on an information processing device, e.g. on a device having a hardware structure identical or similar to the one illustrated by way of example in FIG. 1. An alternative patching method and an information processing device on which the alternative patching method is implemented will be discussed with reference to FIGS. 4 and 5. Patching methods can of course be implemented on a vast variety of information processing devices, differing in particular in their peripherals such as input and output devices. The information processing device described above with reference to FIG. 1 is intended to be merely illustrative and not in any way limiting. The methods described in the following are, at least in their essence, applicable in conjunction with any information processing device having a memory and a processor.

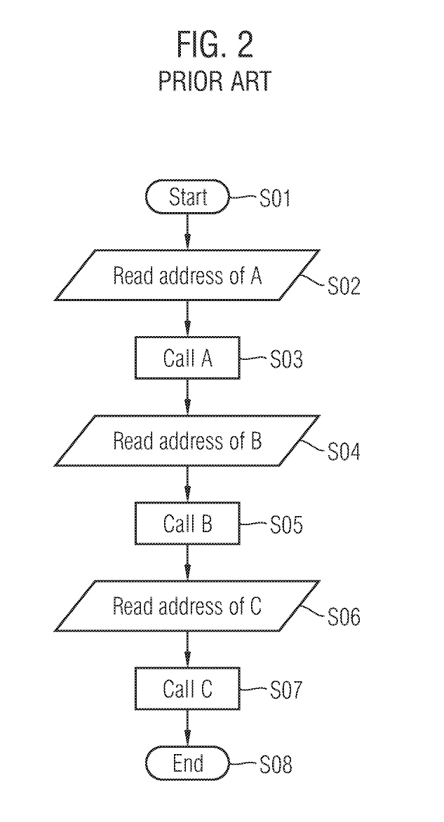

FIG. 2 schematically illustrates a prior art method of executing a program on an information processing device, the program comprising an instruction A, an instruction B and an instruction C to be performed in successive order. The process starts in step S01 by loading some initial instructions which may have been stored in a ROM. Each of the instructions A, B, and C may comprise a very large number of elementary or bit operations to be executed by the processor and is typically implemented by a programmer by means of a piece of code known in the art as a function, subroutine, subprogram, program, process, object, library component, or the like. In a subsequent step S02 the processor reads from a memory a memory address of the instruction A. Depending on whether or not the instruction A has been patched, the address refers to a location in a RAM or in a ROM. In a subsequent step S03 the processor reads the instruction A stored at the memory location specified by the memory address read in the previous step S02. The processor then executes the instruction A. The steps of reading and of executing an instruction are summarily referred to as calling the instruction. The subsequent steps S04 to S07, relating to instructions B and C, are performed analogously to steps S02 and S03 described above. Thus, in step S04, the processor reads the memory address of a location at which instruction B has been stored. That location may be in a read-only memory or in a random access memory, depending on whether or not instruction B has been patched. In a subsequent step S05, the processor calls the instruction B. Next, in step S06, processor reads a memory address indicating a location in memory where instruction C has been stored. If instruction C has been patched, the memory address read in step S06 refers to a location within the RAM, whereas if instruction C has not been patched, the memory address refers to a location within the ROM. In the subsequent step S07 the processor reads and executes the instruction C. The process ends in a final step S08. Each of the reading steps S02, S04 and S06 corresponds to a jump point in a program for executing the steps S01 to S08. Typically the reading instructions S02, S04 and S06 are stored in the ROM. However, alternatives are possible. For example, the instruction to read the memory address of instruction A (or B or C) may be part of a patch instruction stored in the ROM.

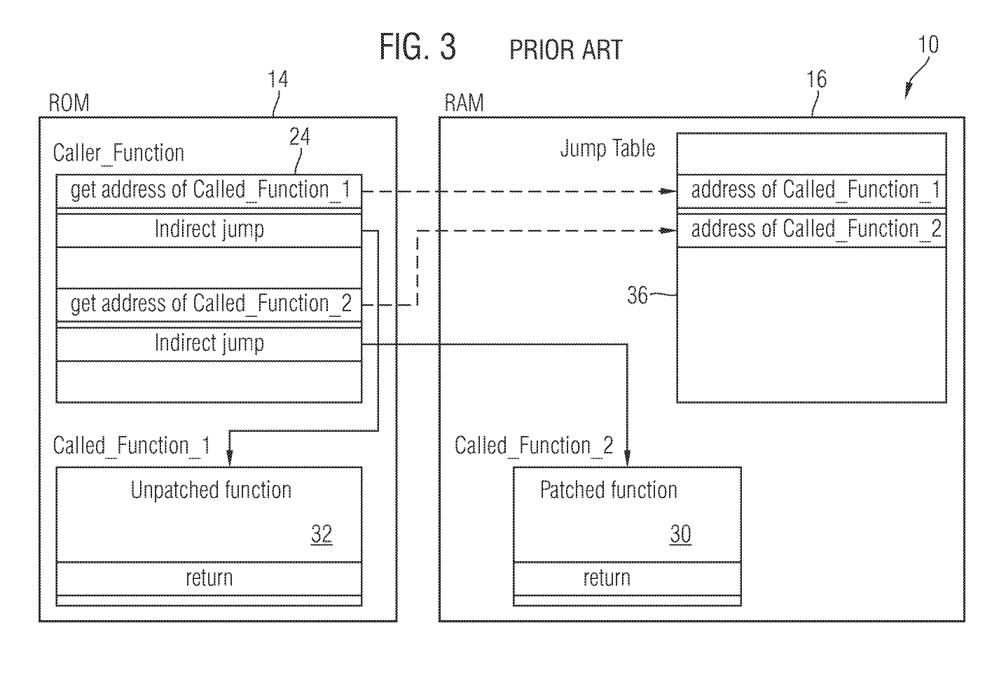

Referring now to FIG. 3, there is schematically shown an information processing device 10 according to the prior art, the device comprising a memory 14, 16 carrying a program 24, 32, 30, 36 and a processor (not shown) capable of executing the program. The program comprises a caller function 24 stored in a ROM 14 and comprising a call to a first function “Called_Function_{—}1” stored in the ROM 14 and a call to a second function “Called_Function_{—}2” stored in the RAM. The first function “Called_Function_{—}1” comprises an original function 32, whereas the second function “Called_Function_{—}2” comprises a patch function 30. During operation of the device 10 the processor executes instructions as prescribed by the caller function 24. The caller function 24 comprises a first instruction “get address of Called_Function_{—}1” in which the memory address of the first function “Called_Function_{—}1” is read from a jump table 36 stored in the RAM 16. The address of the first function “Called_Function_{—}1” refers to the function's location in the ROM 14. The caller function 24 then instructs the processor to jump to the address of the first function “Called_Function_{—}1” and to perform the instructions read at that address, that is, the instructions as prescribed by the first function “Called_Function_{—}1”. The first function comprises the original function 32 followed by a return statement instructing the processor to jump back to the caller function 24. In a subsequent step, after jumping back to the caller function 24, the processor reads an instruction “get address of Called_Function_{—}2” instructing the processor to read a memory address of the second function “Called_Function_{—}2”. The address of the second function “Called_Function_{—}2” refers to a location in the RAM 16 at which the second function has been stored. The processor then performs a jump to that memory location in the RAM 16 and calls (that is, reads and executes) the second function “Called_Function_{—}2”. The second function “Called_Function_{—}2” comprises the patch function 30 followed by a return instruction instructing the processor to jump back to the caller function 24.

For the sake of simplicity, the caller function 24 is shown to comprise only two jump points indicated respectively as “indirect jump”. In practice a program having substantial portions stored in a ROM may comprise hundreds of jump points. Since each jump point is associated with a memory address in a jump table, the memory address indicating the location of either an original or a patch instruction, the jump table may occupy a substantial portion of the RAM's capacity. Another drawback of the prior-art patching methods is that there is a code size overhead in searching the function in the patch table (even if this is done by a function) and then calling the function indirectly (that means through the pointer obtained). On most processing architectures this is done using more instructions than by a direct call. This is significant in comparison with the proposed method because the latter is “per call”, meaning that this cost is added every time a function is called, and a function may be called from at least once to four or five times or even many times more. If one patches 100 functions that are called in average five times each, the code size cost will be charged 500 times. In the present method, the added size cost (by the call to a patch trigger, see FIG. 5 and the discussion thereof) is charged only once per patched function, because the ROM code always calls the same function address. Also, it is a direct call to the function. Thus less code is generated per function call. If one patches 100 functions that are called 500 times, the code-size patch cost is charged 100 times.

Turning now to FIG. 4, there is shown in a schematic and simplified manner an example of a method of executing a program on an information processing device. The information processing device may comprise a memory carrying the program and a processor capable of executing the program. The method comprises the steps of determining S12 whether an identifier identifying a selected original instruction is contained in a set of identifiers, executing S13 the original instruction if it is determined that the identifier is not contained in the set of identifiers, and executing S14 a patch instruction identified by the identifier if it is determined that the identifier is contained in the set of identifiers. The information processing device may in particular comprise a read-only memory (ROM) and a random access memory (RAM). Hence the step of executing the original instruction S13 may comprise reading the original instruction from the ROM, and the step of executing the patch instruction S14 may comprise reading the patch instruction from the RAM.

In the following more detailed discussion of an exemplary embodiment of the method it is assumed that original instructions are stored in a ROM while patch instructions are stored in a RAM. However it is pointed out that the method can be performed using arbitrary types of memory hardware.

The method starts in step S10. In step S11 a processor reads a set of identifiers, each identifier unambiguously identifying an instruction stored in the ROM. Each identifier may for example be a memory address of the instruction the identifier relates to. Alternatively each identifier could be an alphanumerical constant, for example an integer number, or a name of a subroutine written by a programmer for implementing the instruction. For example, if the program comprises a total of N instructions with patching support, these instructions could be numbered 1 to N. The set of identifiers is stored in the RAM and may thus be modified at will for modifying the program. In a subsequent step S12 it is determined whether the identifier identifying an instruction A is contained in, i.e. whether it is an element of, the set of identifiers. If the processor determines that the identifier identifying instruction A is not contained in the set of identifiers, the processor reads and executes in step S13 an original instruction A stored in the ROM. Otherwise, that is, if the processor determines that the identifier is contained in the set of identifiers, the processor reads and executes in step S14 a patch instruction A′ stored in the RAM.

In the subsequent steps S15 to S20 analogous steps are performed for executing either an original instruction B or a patch instruction B′, and an original instruction C or a patch instruction C′. Thus, in step S15 it is determined whether an identifier identifying the original instruction B is contained in the set of identifiers. If the identifier is not contained in the set of identifiers, the processor calls, in step S16, the original instruction B stored in the ROM. Otherwise the processor calls, in step S17, a patch instruction B′. Similarly it is determined in subsequent step S18 whether an identifier identifying an original instruction C is an element of the set of identifiers stored in the RAM. If the identifier identifying the original instruction C is found not to be an element of the set of identifiers, the processor calls in step S19 the original instruction C, whereas if it is found to be an element of the set of identifiers, the processor calls, in step S20, a patch instruction C′ stored in the RAM. The method ends in step 21.

According to a specific embodiment, to be described in greater detail with reference to FIG. 5, the ROM code always calls instruction (function) A. Function A, in turn, calls a patch trigger with a parameter identifying function A. Based on this parameter, the ROM patch trigger determines whether the function has been patched, in which case it needs to call function A′. If A has not been patched, the control is returned to function A. If function A has been patched, the ROM patch trigger calls A′. After the execution, function A′ will return to the caller of function A. This is a very important step, for several reasons. It enables the ROM code to always call the same function A. The mechanism will ensure that the proper code is executed (A or A′), transparently for the ROM code. This is not a standard step. Normally, the control would return from A′ to its caller (the ROM patch trigger), then to A. But this regular way of functioning would corrupt the context for the caller ROM code.

Still referring to the specific embodiment illustrated by way of example in FIG. 4, at each instance where the processor determines that the identifier identifying a particular original instruction is not contained in the set of identifiers, the processor simply moves on to read the original instruction. Hence there is no need of storing in the RAM the memory addresses of those instructions which have not been patched. Only in the case where an instruction has been patched, some information needs to be provided in the RAM for enabling the processor to call the patch instruction. As compared to the prior art method described with reference to FIG. 2, the present method does not require storing a jump table or analogous structure containing the memory addresses of all instructions. Thus, the information that still needs to be stored may occupy substantially less memory in the RAM. This is particularly the case if only a minor portion of the original instructions are patched, which in practice is by far the most common situation. Another difference with respect to the prior art resides in the usability for implementation. In the prior art, if an existing program needs to be moved to ROM for a future revision of the product and has to be modified to support patching, the whole source code needs to be heavily modified—all function calls needs to be rewritten, due to the necessary search in the jump table and the indirect function call. Using the present method, a single function call may be added at the beginning of every function that one wishes to be able to call. This causes much less effort and leads to more easily controllable changes in the code.

Turning now to FIG. 5, there is shown in a schematic and simplified manner an example of an information processing device 10 comprising a memory 14, 16 carrying a program 24, 26, 28, 22, 30, 32, and a processor (not shown) capable of executing the program. The program 24, 26, 28, 22, 30, 32 instructs the processor to determine whether a selected identifier is contained in a set of identifiers, and, if the processor has determined that the identifier is contained in the set of identifiers, to execute a patch instruction 30 identified by the identifier, and, if the processor has determined that the identifier is not contained in the set of identifiers, to execute an original instruction 32 identified by the identifier. In the example of FIG. 5, the memory 14, 16 comprises a read-only memory 14 and a random access memory 16, the ROM 14 containing the original instruction 34 and the RAM containing the patch instruction 30 and the set of identifiers. In the example shown, the RAM 16 contains instructions 22 for determining whether the identifier is contained in the set of identifiers. Alternatively the ROM 14 may contain instructions for determining whether the identifier is contained in the set of identifiers. The identifier may for example be a digital constant. The identifier may, for example, be a memory address of the original instruction. Alternatively the identifier may occupy less memory than a memory address of the instruction. This is possible due to the fact that the number of instructions with patching support is smaller than the number of memory addresses of the ROM. In fact, usually the number of instructions with patching support is many times smaller than the number of memory addresses in the ROM. The processor may for example comprise an ARM7 core or any other suitable processing core. The information processing device 10 may, for example, be mounted on a single chip. The information processing device 10 may, for example, be part of a mobile station for use within a wireless communication network. The mobile station may in particular be a portable phone. The program stored in the memory 14, 16 comprises various portions of code some of which are stored in the ROM while others are stored in the RAM. The principal body of the program code is provided by a caller function 24 stored in the ROM and comprising a call to a first function “Called_Function_{—}1” and a call to a second function “Called_Function_{—}2”. Both the first function “Called_Function_{—}1” and the second function “Called_Function_{—}2” are contained in the ROM 14 and comprise respectively an original instruction 32 and an original instruction 34. As the program is executed the processor jumps to the first function “Called_Function_{—}1”, which in turn instructs the processor to call a trigger program 22 stored in the RAM 16. The trigger program 22 then causes the processor to identify the first function “Called_Function_{—}1” and thus the original instruction 32. More specifically, the first function “Called_Function_{—}1” 26 passes to the trigger program 22 an identifier identifying itself. The trigger program 22 then instructs the processor to determine whether the identifier identifying the first function “Called_Function_{—}1” (and thus the original instruction 32) is contained in a set of identifiers stored in the RAM 16. In the example shown, the identifier of the original instruction 32 is not contained in the set of identifiers, indicating that the original instruction 32 has not been patched. Upon determining that the original instruction 32 has not been patched, the processor returns to the first function “Called_Function_{—}1” to execute the original instruction 32. After executing the original instruction 32 the processor jumps back to the caller function 24 which instructs it to call the second function “Called_Function_{—}2”. The second function “Called_Function_{—}2” redirects the processor to the trigger program 22 and passes to the trigger program 22 an identifier identifying itself and thus the original instruction 34. By determining whether the identifier identifying the original instruction 34 is contained in the set of identifiers stored in the RAM 16, the processor determines whether the original instruction 34 has been patched or not. In the example shown in the Figure, the identifier identifying the original instruction 34 is contained in the set of identifiers. The processor thus determines that the original instruction 34 has been patched and accordingly executes a third function “Called_Function_{—}2_replacement” stored in the RAM 16, the third function containing the patch instruction 30 and a return instruction for instructing the processor to return to the caller function 24. Upon execution of the patch instruction 30, the processor thus returns directly to the caller function 24, without returning to the trigger program 22. Thereby executing the original instruction 34 after the patch instruction 30 is avoided. The direct return from the patch instruction 30 to the caller function 24 may be implemented by determining the required return address during execution of the program. Thus the program further instructs the processor to perform the following steps: if the processor has determined that the identifier is contained in the set of identifiers and the patch instruction 30 identified by the identifier has been executed, execute a return instruction bypassing the corresponding original instruction 34, and if the processor has determined that the identifier is not contained in the set of identifiers, execute a return instruction leading to the execution of the original instruction 34. Effectively the processor thus executes the patch instruction 30 instead of the original instruction 34. For the sake of clarity only two original instructions, namely the original instruction 32 and the original instruction 34, have been represented in the Figure. The program may of course comprise an arbitrary number of instructions.

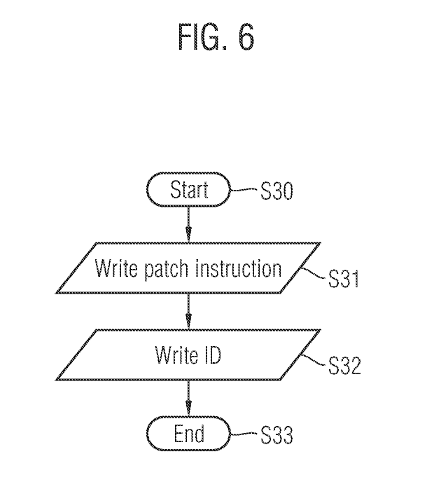

Referring now to FIG. 6, there is illustrated in a schematic and simplified manner an example of a method of modifying a program on an information processing device. The method comprises the steps of storing S31 a patch instruction for being executed instead of an original instruction, and adding S32 an identifier to a set of identifiers, the identifier identifying the original instruction. The information processing device may comprise a read-only memory (ROM) and a random access memory (RAM), wherein the ROM carries the original instruction. The step of storing S31 may then comprise writing the patch instruction to the RAM, and the step of adding S32 may comprise writing the identifier to the RAM.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of system 10 are circuitry located on a single integrated circuit or within a same device. Alternatively, system 10 may include any number of separate integrated circuits or separate devices interconnected with each other. For example, the read-only memory 14 may be located on a same integrated circuit as the processor 12 or on a separate integrated circuit or located within another peripheral discretely separate from other elements of system 10. I/O circuitry 18, 20 may also be located on separate integrated circuits or devices. Also for example, system 10 or portions thereof may be soft or code representations of physical circuitry or of logical representations convertible into physical circuitry. As such, system 10 may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. The terms “a” or “an,” as used herein, are defined as one or more than one. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An information processing device comprising:
a memory carrying a program; and
a processor capable of executing the program, the program when executed instructing the processor to perform the following steps:
determine whether a selected identifier is contained in a set of identifiers;
if the processor has determined that the identifier is contained in the set of identifiers, execute a patch instruction identified by the identifier; and
if the processor has determined that the identifier is not contained in the set of identifiers, execute an original instruction identified by the identifier;
wherein the identifier is an alphanumerical constant and not a memory address.

2. The information processing device as claimed in claim 1, wherein the program when executed further instructs the processor to perform the following steps:
if the processor has determined that the identifier is contained in the set of identifiers and the patch instruction identified by the identifier has been executed, execute a return instruction bypassing the corresponding original instruction; and
if the processor has determined that the identifier is not contained in the set of identifiers, execute a return instruction leading to the execution of the original instruction.

3. The information processing device as claimed in claim 1, wherein the memory comprises a read-only memory (ROM) and a random access memory (RAM), the ROM carries the original instruction, and the RAM carries the patch instruction and the set of identifiers.

4. The information processing device as claimed in claim 3, wherein the RAM carries instructions for determining whether the identifier is contained in the set of identifiers.

5. The information processing device as claimed in claim 3, wherein the ROM carries instructions for determining whether the identifier is contained in the set of identifiers.

6. The information processing device as claimed in claim 1, or wherein the identifier occupies less memory than a memory address of the instruction.

7. The information processing device as claimed in claim 1, wherein the information processing device is mounted on a single chip.

8. The information processing device as claimed in claim 1, wherein the information processing device is part of a mobile station for being used within a wireless communication network.

9. A method of executing a program on an information processing device, comprising:
determining whether an identifier identifying a selected original instruction is contained in a set of identifiers;
executing a patch instruction identified by the identifier if it is determined that the identifier is contained in the set of identifiers; and
executing the original instruction if it is determined that the identifier is not contained in the set of identifiers;
wherein the identifier is an alphanumerical constant and not a memory address.

10. The method as claimed in claim 9, wherein:
the information processing device comprises a read-only memory (ROM) and a random access memory (RAM);
the step of executing the original instruction comprises reading the original instruction from the ROM; and
the step of executing the patch instruction comprises reading the patch instruction from the RAM.

11. A method performed by an information processing device, comprising:
storing a patch instruction for being executed instead of an original instruction; and
adding an identifier to a set of identifiers, the identifier identifying the original instruction;
wherein the identifier is an alphanumerical constant and not a memory address.

12. The method as claimed in claim 11, wherein
the information processing device comprises a read-only memory (ROM) and a random access memory (RAM);
the ROM carries the original instruction;
the step of storing comprises writing the patch instruction to the RAM; and
the step of adding comprises writing the identifier to the RAM.

13. The information processing device as claimed in claim 2, wherein the memory comprises a read-only memory (ROM) and a random access memory (RAM), the ROM carries the original instruction, and the RAM carries the patch instruction and the set of identifiers.

14. The information processing device as claimed in claim 2, wherein the identifier occupies less memory than a memory address of the instruction.

15. The information processing device as claimed in claim 3, wherein the identifier occupies less memory than a memory address of the instruction.

16. The information processing device as claimed in claim 4, wherein the identifier occupies less memory than a memory address of the instruction.

17. The information processing device as claimed in claim 5, wherein the identifier occupies less memory than a memory address of the instruction.

18. The information processing device as claimed in claim 1, wherein the information processing device is mounted on a single chip.

19. The information processing device as claimed in claim 4, wherein the information processing device is mounted on a single chip.

20. The information processing device as claimed in claim 5, wherein the information processing device is mounted on a single chip.
